(19) United States
(12) Patent Application Publication
(10) Pub. No.: US 2013/0158844 A1
(43) Pub. Date: Jun. 20, 2013

(54) METHOD FOR OPERATING A CONTROL UNIT

(71) Applicant: Torsten GRAHLE, Bietigheim (DE)

(72) Inventor: Torsten GRAHLE, Bietigheim (DE)

(21) Appl. No.: 13/711,906

(22) Filed: Dec. 12, 2012

(30) Foreign Application Priority Data
Dec. 15, 2011 (DE) 10 2011 088 764.4

(51) Int. Cl. F02D 45/00

(52) U.S. Cl. CPC F02D 45/00
USPC 701/114; 701/102

(57) ABSTRACT

A method for operating a control unit for an internal combustion engine is described, the control unit together with at least one additional control unit actuating the internal combustion engine in a first operating mode, wherein the control unit monitors the at least one additional control unit for a malfunction and/or failure, and in the event of a malfunction and/or failure of the at least one additional control unit, the control unit switches from the first operating mode to a second operating mode, in which the control unit is able to maintain an operation of the internal combustion engine independently of the at least one additional control unit.

### CROSS REFERENCE TO RELATED APPLICATION

The present application claims priority to Application No. DE 10 2011 088 764.4, filed in the Federal Republic of Germany on Dec. 15, 2011, which is incorporated herein in its entirety by reference thereto.

### FIELD OF INVENTION

The present invention relates to a method for operating a control unit for an internal combustion engine, in which the control unit together with at least one additional control unit actuates the internal combustion engine in a first operating mode. In addition, the present invention relates to a control unit for an internal combustion engine.

### BACKGROUND INFORMATION

Such methods and devices are already known and used, for instance, to control boat motors or large stationary motors. One disadvantage of the known systems is that when a control unit malfunctions, the still functioning remaining control unit(s) is/are unable to ensure a further operation of the internal combustion engine by themselves. Therefore, the entire control unit system is usually switched off completely, even if only a single control unit malfunctions, which makes a further operation of the internal combustion engine impossible.

### SUMMARY

Therefore, it is an object of the present invention to improve a method and a device of the type mentioned at the outset in such a way that a reliable operation of the internal combustion engine is ensured even in the event of control unit malfunctions.

In the method of the type mentioned in the introduction, the present invention achieves this objective in that the control unit monitors the at least one additional control unit for a malfunction and/or failure, and that in the event of a malfunction and/or a failure of the at least one additional control unit, the control unit switches from the first operating mode to a second operating mode, in which the control unit is able to maintain an operation of the internal combustion engine independently of the at least one additional control unit. This advantageously ensures that the internal combustion engine may continue to be operated even if at least one control unit or additional control units of a control unit system malfunction(s).

In one advantageous development, the control unit cooperates with the at least one additional control unit of a control unit system in accordance with the master-slave principle in the first operating mode, the control unit optionally operating as slave control unit or as master control unit.

The function of a control unit operating as slave control unit typically depends on the function of a master control unit controlling it. For example, the master control unit may input specifications for the operation of the slave control unit or for the operation of corresponding components of the internal combustion engine controlled by the slave control unit. This means that the slave control unit usually is unable to properly actuate the internal combustion engine or functional components of the internal combustion engine assigned to the slave control unit, if the master control unit assigned to it fails to transmit corresponding instructions to the slave control unit. This leads to a total failure in conventional control unit systems as a result of the failure or a malfunction of the master control unit alone.

In contrast, a control unit operating as master control unit as a rule is able to actuate at least the functional components of the internal combustion engine that were assigned to it, without having to rely on the functionality of one or multiple slave control units assigned to it for this purpose. However, this too generally leads to a total failure or shutdown of the internal combustion engine in conventional control unit systems, because a conventional master control unit is unable to compensate for the loss of a slave control unit.

In the second operating mode according to the present invention, on the other hand, it is possible to maintain at least an emergency operation of the internal combustion engine, even if a failure occurs in one or multiple control unit(s) of a system.

In one further advantageous exemplary embodiment, the switching of the control unit from the first to the second operating mode takes place in that the control unit triggers a software reset. This very advantageously ensures that all function components, especially program modules of the computer program running on the control unit, are put into a defined initial state in order to subsequently ensure the operation of the internal combustion engine in the second operating mode of the control unit.

As an alternative to a software reset, it is also possible that the control unit changing the operating mode correspondingly resets all program modules of a software running thereon that are affected by the change in operating mode, from an operation in the first operating mode to an operation in the second operating mode. This advantageously makes it possible to dispense with a software reset for the switch in operating modes.

In one additional advantageous exemplary embodiment, prior to triggering the software reset, the control unit defines a state variable that characterizes the intended switch of the control unit from the first to the second operating mode, and the control unit evaluates the state variable in an initialization phase that follows the software reset. By assigning a corresponding value to the state variable, the control unit thus is able to retain the information that a change from the first operating mode to the second operating mode is to take place beyond the software reset. While all data from a volatile working memory (RAM, Random Access Memory) of the control unit typically are lost during the software reset, the value of the state variable defined according to the present invention is retained, so that the control unit, after the software reset, may analyze the state variable and detect that it is now no longer to be operated in the first operating mode but in the second operating mode, which allows at least an emergency operation of the internal combustion engine.

In one further advantageous exemplary embodiment, the control unit operates as master control unit in the second operating mode. This means that the second operating mode according to the present invention is comparable to a master operating mode from the master-slave working principle mentioned previously already. During standard operation, a control unit according to the present invention thus is able to be actuated in fault-free manner as slave control unit, for instance, by a corresponding actuation by an additional control unit operating as master control unit, and able to initially control the operation of the internal combustion together with the master control unit. For example, the control unit may control a first cylinder row of the internal combustion engine, while the additional control unit, developed as master control unit, actuates a further cylinder row of the internal combustion engine on its own. As soon as a malfunction of the master control unit occurs, which is detectable by the control unit due to the monitoring of the additional control unit according to the present invention, the control unit according to the present invention is advantageously able to switch from the current slave operating mode to the second operating mode, which is comparable to a master operating mode according to the exemplary embodiment at hand, so that it is now able to control the function components of the internal combustion engine essentially independently, especially independently of the now unavailable further control unit. In supplementation of a conventional master operation, the control unit according to the present invention is furthermore designed in such a way that it does not necessarily require an additional (slave) control unit to operate the internal combustion engine. Instead, in the second operating mode, the control unit according to the present invention is able to operate the internal combustion engine completely autonomously at least in an emergency operation, i.e., without support from the failed control unit.

To prevent that the additional control unit having a malfunction or a complete failure interferes in a communication of the control unit with the internal combustion engine, or generally in the actuation of the internal combustion engine by the properly operating control unit, in one further advantageous development the control unit blocks a function of the at least one additional control unit in the second operating mode, especially in that it deactivates an electrical power supply of the at least one additional control unit. This advantageously ensures that after the control unit has changed its operating mode to the second operating mode, interference by a defective control unit in the control of the internal combustion engine in the second operating mode is advantageously suppressable. For example, in the case of a data bus (e.g., a CAN bus) jointly used by the control units, interference by the defective or failing control unit in the entire data bus is therefore prevented.

In one further advantageous exemplary embodiment, the control unit signals the switch to the second operating mode, especially acoustically and/or optically. Signaling via data connections to other control units, etc. is conceivable as well. For example, a signal lamp of an operator panel of the internal combustion engine or the like may be used for signaling. Similar signaling is also able to take place during the entire second operating mode, or at least periodically within this second operating mode, that is to say, not only within the framework of a change in operating modes.

A control unit is exemplarily described as a further means for achieving the object of the present invention.

Additional features, application options and advantages of the present invention result from the following description of exemplary embodiments of the present invention, which are shown in the accompanying drawings. All of the described or illustrated features form the subject matter of the present invention, individually or in any combination, regardless of their combination in the patent claims or their antecedent reference, and also regardless of their formulation or illustration in the description or in the drawings.

### BRIEF DESCRIPTION OF THE DRAWINGS

FIG. 1 shows a block diagram of a first exemplary embodiment of the present invention, in a schematic representation.

FIG. 2 shows a simplified flow chart of one exemplary embodiment of the method according to the present invention.

FIG. 3 shows a simplified flow chart of a further exemplary embodiment of the method according to the present invention.

### DETAILED DESCRIPTION

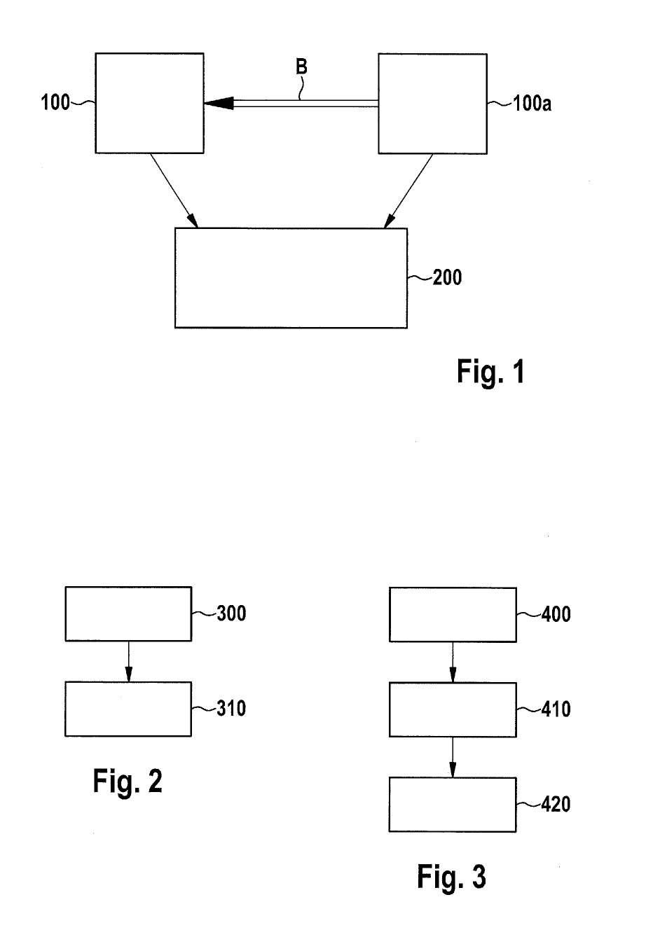

FIG. 1 schematically illustrates an internal combustion engine 200, to which a total of two control units 100, 100a has been assigned for the control of internal combustion engine 200. Internal combustion 200, for example, is a Diesel engine having two cylinder rows provided with six cylinders in each case (not shown).

The actuation of internal combustion engine 200 is carried out by both control units 100, 100a. In the case at hand, control units 100, 100a operate in a control unit system according to the master-slave principle, in such a way that additional control unit 100a assumes a master function, and control unit 100 assumes a slave function.

For example, control unit 100 may be provided to actuate a first cylinder row of internal combustion engine 200. In contrast, additional control unit 100a may be provided to actuate at least one further cylinder row of internal combustion engine 200. Since control unit 100 is developed as slave control unit here, the actuation of its assigned cylinder row of internal combustion engine 200 takes place as a function of control information B, which master control unit 100a transmits to control unit 100 (see block arrow B).

An actuation of the particular function components (e.g., cylinder rows, injectors) of internal combustion engine 200 by individual control units 100, 100a is illustrated by the arrows (not further denoted in FIG. 1) from the particular control units 100, 100a to internal combustion engine 200.

According to the present invention, control unit 100 monitors the at least one additional control unit 100a for a malfunction and/or failure. A corresponding step 300 of the method according to the present invention is indicated in the flow diagram according to FIG. 2.

If control unit 100 detects a malfunction and/or a failure of master control unit 100a, it advantageously changes to a second operating mode in a subsequent method step 310, in which control unit 100 is able to maintain an operation of internal combustion engine 200 independently of the at least one additional control unit 100a.

This means that prior to the occurrence of an error in master control unit 100a, this master control unit 100a actuates control unit 100 by means of control instruction B in order to enable control unit 100, which is currently operating as slave control unit, to actuate corresponding function components (cylinder rows) of internal combustion engine 200 on its own. In parallel, master control unit 100a itself also directly actuates function components (other cylinder rows) of internal combustion engine 200 that are specially assigned to it.

However, as soon as control unit 100 detects an error or a complete failure of its master control unit 100a according to the method of the present invention (step 300 in FIG. 2), control unit 100 (FIG. 1) advantageously switches from the slave operating mode (first operating mode) to a second operating mode provided according to the present invention, in which control unit 100 no longer has a functional dependency from master control unit 100a (block arrow B from FIG. 1) with regard to the actuation of internal combustion engine 200, so that control unit 100 advantageously is able to actuate internal combustion engine 200, without requiring a proper operation or actuation by master control unit 100a.

This advantageously makes it possible to realize at least an emergency operation of internal combustion engine 200. The second operating mode in control unit 100, for instance, may be realized in that control unit 100 continues to actuate the function components of internal combustion engine 200 it was assigned during the first operating mode, but now possibly uses other actuation parameters, which allow a reliable operation even after the functionality of additional control unit 100a is no longer available. In addition, in the second operating mode, control unit 100 may at least partially also undertake an actuation of function components that are directly controlled by master control unit 100a during standard operation, i.e., during the first operating mode.

This advantageously ensures that a failure of additional control unit 100a is reliability detected and that corresponding countermeasures (second operating mode or emergency operation) are able to be initiated.

In another advantageous exemplary embodiment of the present invention, control unit 100 defines a state variable which characterizes the intended switch of control unit 100 from the first to the second operating mode, see step 400 from FIG. 3.

Subsequently, i.e., in step 410, control unit 100 executes a software reset. In a following step 420, control unit 100 finally runs through an initialization phase following the software reset, in which the previously defined state variable is analyzed. This makes it possible for control unit 100 to detect that it is changing from the first to the second operating mode beyond software reset 410. Accordingly, control unit 100 may utilize, for example, a program sequence control that is modified in comparison with the first operating mode for the operation in the second operating mode, thereby ensuring that the operation of internal combustion engine 200 is maintained even when control unit 100a is unavailable due to failure.

In one further advantageous exemplary embodiment, both control units 100, 100a use similar software for controlling their operation. By reading in a digital input of the particular control unit 100, 100a, it is possible, for instance, to detect during the initialization phase of control units 100, 100a whether the particular control unit 100, 100a is to operate as master or as slave. Toward this end, a switch to a dedicated program sequence control (scheduling) and to a corresponding dedicated data set takes place. In addition, switches in the software to special branchings in the functions that realize the operation or the actuation of internal combustion engine 200 may take place as a function of the operating mode (master/slave).

After an error or the failure of control unit 100a has been detected according to the present invention, the already described software reset 410 (FIG. 3) is implemented on the still functioning control unit 100, using a defined code for the state variable. In the initialization phase that follows the software reset, for example the previously mentioned digital input for the differentiation between master-slave operation is disregarded when analyzing the state variable. This means that control unit 100 detects that it is now no longer used in a correctly operating master-slave system and may optionally work as master or as slave control unit. Instead, the state variable defined according to the present invention signals to control unit 100 that a change to the second operating mode (emergency operation) is desired. Accordingly, a program sequence control of control unit 100 is prepared for the switch to the second operating mode. For example, the program sequence control may be switched to a program sequence control that is comparable to the master operation, which may possibly have to take into account that control unit 100 now operating as master control unit is unable to actuate failed control unit 100a as its slave control unit, but instead must now realize the operation of internal combustion engine 200 on its own.

In one additional advantageous exemplary embodiment, it is furthermore possible to ensure that defective control unit 100a is no longer able to actively participate in the driving or the actuation of internal combustion engine 200, in that, for instance, the electrical energy supply of defective control unit 100a is deactivated by still operating control unit 100. As an alternative or in addition, it is also possible to use blocking messages on jointly utilized data or communication buses (e.g., CAN bus) of control units 100, 100a, or a hardware block via I0-lines.

Moreover, it is especially advantageous if the emergency operation of internal combustion engine 200 realized by the second operating mode is unable to be left again automatically. This may be ensured, for example, by deactivating an error recovery known from conventional control units. This means that, once an error or a malfunction or a total failure of control unit 100a that resulted in a switch of the still operating control unit 100 to the second operating mode has been detected, the control unit system cannot be automatically returned to a fault-free operation, which would cause control unit 100 to leave the second operating mode according to the present invention again in an undesired manner.

In another advantageous exemplary development, control unit 100 signals the change to the second operating mode acoustically and/or optically, such as to the driver of a vehicle equipped with internal combustion engine 200. An operation in the second operating mode is able to be signaled in the same way.

To realize the functionality according to the present invention, it is advantageous if all data or all signals required to operate internal combustion engine 200 are present in control units 100, 100a in redundant manner, if possible, so that each one of control units 100, 100a may assume the second operating mode according to the present invention, if required, and read in corresponding operating variables of internal combustion engine 200 in order to realize a proper actuation of, for instance, injectors of internal combustion engine 200, etc., even if at least one further control unit of the control unit system fails.

It is especially preferred if the engine speed, driver-desired torque, and air mass signals are read in by all control units 100, 100a of the control unit system.

The principle according to the present invention advantageously provides increased availability of internal combustion engine 200. In particular in a failure of one or more control unit(s) 100a of a control unit system, a control unit 100 that is still operating properly is able to realize an emergency operation of internal combustion engine 200. In a particularly advantageous manner, the principle according to the present invention may be used in marine or air traffic applications or also in stationary engines in order to ensure the driving of a vehicle including internal combustion engine 200 for as long as possible or to guarantee the longest possible servicing intervals of the stationary motor.

The present invention may be implemented in a particularly advantageous manner also in the form of a computer program for a computer unit (e.g., a microprocessor or a digital signal processor, DSP), which is provided in a corresponding control unit 100, 100a.

What is claimed is:

1. A method for operating a control unit for an internal combustion engine, comprising:
actuating the internal combustion engine in a first operating mode via the control unit together with at least one additional control unit;
monitoring, by the control unit, the at least one additional control unit for at least one of malfunction and failure; and
in an event of the at least one of malfunction and failure of the at least one additional control unit, switching, by the control unit, from the first operating mode to a second operating mode in which the control unit maintains an operation of the internal combustion engine independently of the at least one additional control unit.

2. The method according to claim 1, wherein the control unit cooperates with the at least one additional control unit in a control unit system according to a master-slave principle in the first operating mode, the control unit operating as a slave control unit or a master control unit.

3. The method according to claim 1, wherein the switching of the control unit from the first operating mode to the second operating mode takes place in that the control unit triggers a software reset.

4. The method according to claim 3, wherein prior to triggering the software reset, the control unit defines a state variable that characterizes an intended switch of the control unit from the first operating mode to the second operating mode, and in an initialization phase following the software reset, the control unit analyzes the state variable.

5. The method according to claim 2, wherein the control unit operates as the master control unit in the second operating mode.

6. The method according to claim 1, wherein in the second operating mode, the control unit blocks a function of the at least one additional control unit by deactivating an electrical energy supply of the at least one additional control unit.

7. The method according to claim 1, wherein the control unit signals the switching to the second operating mode at least one of acoustically and optically.

8. The method according to claim 1, wherein, in the first operating mode, the control unit actuates a first cylinder row, which has at least one cylinder of the internal combustion engine, and the additional control unit actuates a second cylinder row, which differs from the first cylinder row and has at least one cylinder of the internal combustion engine, during the first operating mode.

9. A control unit for an internal combustion engine, the control unit being configured to actuate the internal combustion engine together with at least one additional control unit in a first operating mode;
wherein the control unit is configured to monitor the at least one additional control unit for at least one of malfunction and failure, and in an event of the at least one of malfunction and failure of the at least one additional control unit, to switch from the first operating mode to a second operating mode in which the control unit maintains an operation of the internal combustion engine independently of the at least one further control unit.

10. The control unit according to claim 9, wherein the control unit is configured to cooperate with the at least one additional control unit in a control unit system according to a master-slave principle in the first operating mode, the control unit operating as a slave control unit or a master control unit.

11. The control unit according to claim 9, wherein the control unit is configured to initiate the switch of the control unit from the first operating mode to the second operating mode by triggering a software reset.

12. The control unit according to claim 11, wherein the control unit is configured to define a state variable that characterizes an intended switch of the control unit from the first operating mode to the second operating mode prior to triggering the software reset, and to analyze the state variable in an initialization phase following the software reset.

13. The control unit according to claim 9, wherein the control unit is configured to block a function of the at least one additional control unit in the second operating mode by deactivating an electrical energy supply of the at least one additional control unit.

14. The control unit according to claim 9, wherein the control unit is configured to signal the switch to the second operating mode at least one of acoustically and optically.
